(19) United States
(12) Patent Application Publication
(10) Pub. No.: US 2013/0198168 A1
(43) Pub. Date: Aug. 1, 2013

(54) DATA STORAGE COMBINING ROW-ORIENTED AND COLUMN-ORIENTED TABLES

(71) Applicants: Wei Huang, Los Altos, CA (US); Anurag Singla, Cupertino, CA (US); Yanlin Wang, San Jose, CA (US); Dhiraj Sharan, Sunnyvale, CA (US)

(72) Inventors: Wei Huang, Los Altos, CA (US); Anurag Singla, Cupertino, CA (US); Yanlin Wang, San Jose, CA (US); Dhiraj Sharan, Sunnyvale, CA (US)

(21) Appl. No.: 13/563,506

(22) Filed: Jul. 31, 2012

Related U.S. Application Data
(60) Provisional application No. 61/514,001, filed on Aug. 1, 2011.

(51) Int. Cl. G06F 17/30

(52) U.S. Cl. CPC G06F 17/30424
USPC 707/722; 707/769; 707/771

(57) ABSTRACT

A data storage system includes a query manager to identify storage engines to execute a query. A first storage engine may execute a portion of the query on a row-oriented table and a second storage engine may execute a second portion of the query on a column-oriented table.

### PRIORITY

The present application claims priority to U.S. provisional patent application Ser. No. 61/514,001 filed Aug. 1, 2011, which is incorporated by reference in its entirety.

### BACKGROUND

Historically, database systems were mainly used for online transaction processing (OLTP). Typical examples of such transaction processing systems are sales order entry or banking transaction processing. These transactions access and process only small portions of the entire data and, therefore, can be executed quite fast. Business intelligence applications are a relatively new set of applications relying on long running so-called Online Analytical Processing (OLAP) queries that process substantial portions of the data in order to generate reports for business analysts. For example, in nightly batch jobs, transaction data is sent to the OLAP system so the reports can be generated. Many businesses maintain two different data storage systems, one for OLTP so they can leverage the speed of the OLTP system for daily data, and one for OLAP to provide the business intelligence processing supported by OLAP.

### BRIEF DESCRIPTION OF DRAWINGS

The embodiments are described in detail in the following description with reference to the following figures.

FIG. 1 illustrates an example of a data storage system;

FIG. 2 illustrates an example of a method;

FIG. 3 illustrates an example of a computer system that may be used for the method and system; and

FIG. 4 illustrates an example of a system that may use the data storage system shown in FIG. 1.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a data storage system supports both column-oriented and row-oriented storage in a single data store, such as a database. The database may include database tables that are column-oriented and row-oriented to allow the data storage system to support both column-oriented and row-oriented storage. By combining two different types of storages, the data storage system supports both OLTP and OLAP workloads inside a single data storage system with one data store.

One example of the type of data stored in the data storage system is real-time event data. The event data may be correlated and analyzed to identify security threats. A security event, also referred to as an event, is any activity that can be analyzed to determine if it is associated with a security threat. The activity may be associated with a user, also referred to as an actor, to identify the security threat and the cause of the security threat. Activities may include logins, logouts, sending data over a network, sending emails, accessing applications, reading or writing data, etc. A security threat includes activity determined to be indicative of suspicious or inappropriate behavior, which may be performed over a network or on systems connected to a network. Common security threats, by way of example, are user attempts to gain unauthorized access to confidential information, such as social security numbers, credit card numbers, etc., over a network.

The data sources for the events may include network devices, applications or other types of data sources described below operable to provide event data that may be used to identify network security threats. Event data is data describing events. Event data may be captured in logs or messages generated by the data sources. For example, intrusion detection systems (IDSs), intrusion prevention systems (IPSs), vulnerability assessment tools, firewalls, anti-virus tools, anti-spam tools, and encryption tools may generate logs describing activities performed by the source. Event data may be provided, for example, by entries in a log file or a syslog server, alerts, alarms, network packets, emails, or notification pages.

Event data can include information about the device or application that generated the event and when the event was received from the event source (“receipt time”). The receipt time may be a date/time stamp, and the event source is a network endpoint identifier (e.g., an IP address or Media Access Control (MAC) address) and/or a description of the source, possibly including information about the product's vendor and version. The data/time stamp, source information and other information is used to correlate events with a user and analyze events for security threats.

The data storage system may also store other information to correlate security events with users to identify threats. The information may include user profiles include account IDs associated with each user. The information may also include user account ID history and user account ID authenticator information. The data storage system is not limited to storing security events and may store other information.

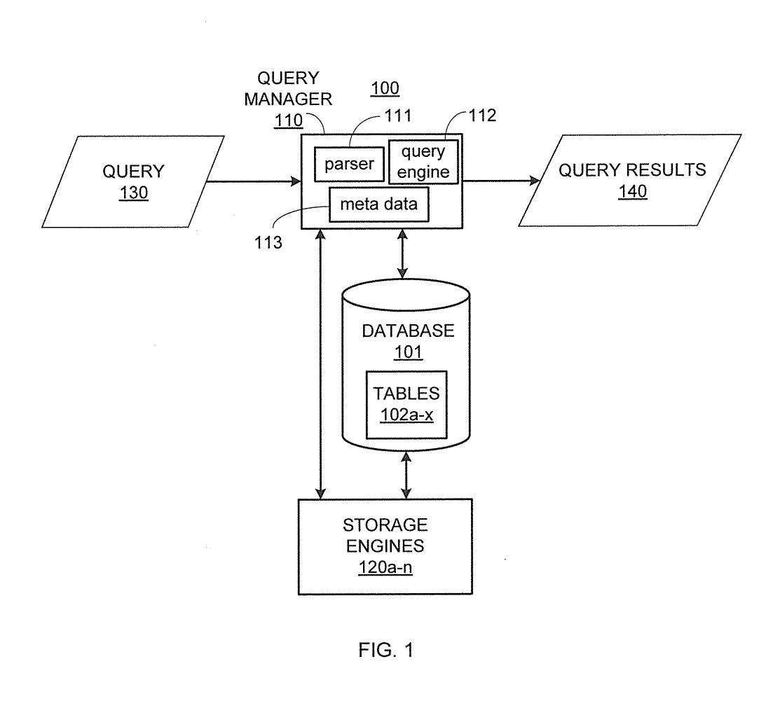

FIG. 1 illustrates a data storage system 100, according to an embodiment. The system 100 includes a database 101, a query manager 110, and storage engines 120a-n. The database 101 stores data, which may include the real-time event data. The database may continuously store the real-time event data as it is received. The query manager 110 may be used to run queries on the data stored in the database 101. The database 101 includes database tables 102a-x. The tables 102a-x are organized as column-oriented or row-oriented. An administrator may decide a proper storage type (e.g., column-oriented or row-oriented) for each table 102a-x. Also, each table 102a-x may store some of the data in the database 101 according to a predetermined model, which may include a predetermined set of fields for the data stored in the table. For example, table 102a stores event data such as data describing events, time of events, etc.; table 102b stores user data such as user profile data of users having accounts; table 103a stores asset data describing assets in the network; and so on.

The query manager 110 receives and runs queries on the data storage system 100. The queries are for data stored in the database 101. The query manager 110 operates with the storage engines 120a-n to run queries on the database 101 using the tables 102a-x. The storage engines 120a-n may be comprised of software including machine readable instructions to create, read, update and delete data from the tables 102a-x. Each storage engine 120a-n may be associated with a particular table or set of tables from the tables a-x. In one example, storage engine 120a operates with row-oriented tables and performs row-based queries on those tables. The storage engine 120b operates with column-oriented tables and performs column-based queries on those tables. The storage engines 120a-n may use APIs to communicate with the query manager 110.

The query manager 110 stores metadata 113 for the storage engines 120a-n and the tables 102a-x. The metadata 113 may indicate the data stored in each table, the storage type of each table and the tables associated with each storage engine. The query manager 110 may use the metadata 113 to select storage engines to run sub queries which may derived from an initial query, shown as query 130, received at the data storage system 100. The query manager 110 includes a query engine 112 that receives queries, such as the query 130. A parser 111 may parse the query 130 into sub queries. The parser 111 may use tokens to identify expressions for the sub queries. The query engine 112 provides the sub queries to the corresponding storage engines 120a-n, and provides query results, such as query result 140, to the user or another computer system. The query engine 112 may perform operations on the results of the sub queries, such as joins, sorts, etc., to generate a response to the initial query 130, shown as query results 140. The query results 140 may be sent to the user or system sending the query 130. The results may be presented via a user interface. The query manager 110 may operate as an upper layer that functions with the storage engines 120a-n in a lower level to execute a query. The data storage system 100 may use the different layers to perform seamless joins between row-oriented and column-oriented tables to achieve high performance and to make the table storage type transparent to users.

An example of executing a query by the data storage system 100 is now described. For example, a user wants to determine whether there are any security threats on a network. The user may send the query 130 to detect failed logins within the last five minutes, and the user wants the query results sorted by user and subnet.

The query manager 110 receives the query 130 and determines sub queries from the query 130. The sub queries may include a sub query for events for failed log-ins in the last five minutes; a sub query for users to determine information for the users associated with the events, and a sub query for assets to determine the subnets for the users. The query manager 110 may determine the sub queries by parsing the query for each type of requested data, which in this example includes event data, user data and asset data. The query manager 110 uses the meta data for the tables 102a-x to identify the storage engines that can run the sub queries. For example, the meta data may indicate that the table 102a stores event data, including events for failed logins, and is associated with storage engine 120a; the table 102b stores user data and is associated with storage engine 120b; and the table 102c stores asset data and is associated with storage engine 120c. The query manager 110 sends each sub query to the corresponding storage engine. Each storage engine performs a row-oriented or column-oriented query depending on the table storage type and sends the results to the query manager 110. The query manager 110 performs joins on the results and sorts the results to present to the user as query results 140.

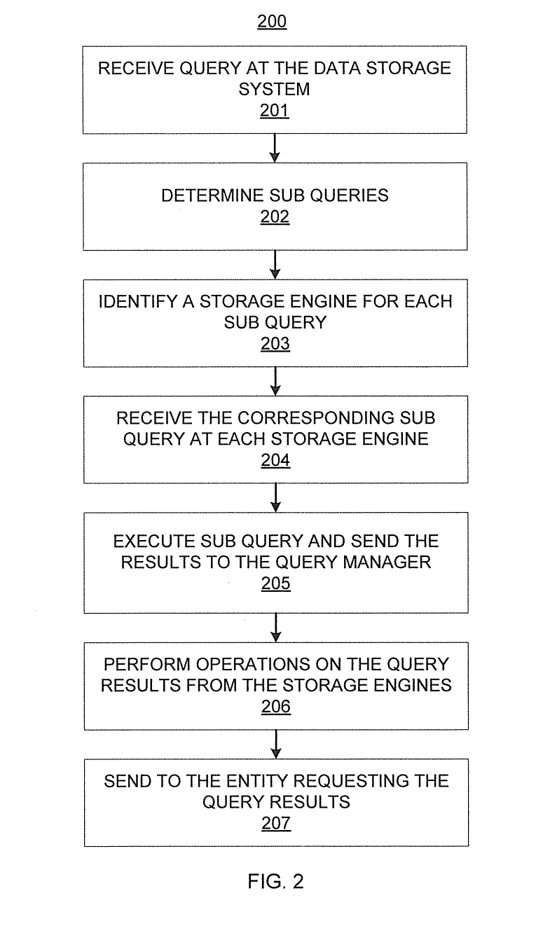

FIG. 2 illustrates a method 200 for executing a query, according to an embodiment. The method 200 is described with respect to the data storage system 100 shown in FIG. 1 by way of example and not limitation. The method 200 may be performed by other systems.

At block 201, the data storage system 100 receives the query 130. At block 202, the query manager 110 parses the query 130 to determine sub queries. At block 203, the query manager 110 identifies a storage engine for each sub query using the meta data for the tables 102a-x and the storage engines 120a-n. At block 204, each storage engines identified at block 202 receives the corresponding sub query. At block 205, each storage engine executes the sub query and sends the results to the query manager 110. At block 206, the query manager 100 performs operations on the query results from the storage engines, such as joins, sorts, etc., to generate the query results 140. At block 207, the query results 140 are sent to the entity requesting the query results.

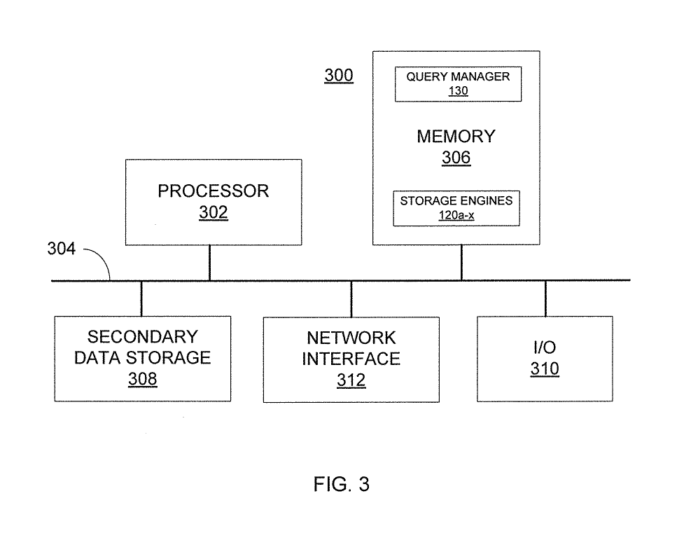

FIG. 3 shows a computer system 300 that may be used with the embodiments described herein. The computer system 300 represents a generic platform that includes components that may be in a server or another computer system. The computer system 300 may be used as a platform for the data storage system 100. The computer system 300 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 300 includes at least one processor 302 that may implement or execute machine readable instructions performing some or all of the methods, functions and other processes described herein. By way of example, the query manager 130 and the storage engines 120a-x comprises machine readable instructions stored in the memory 306 during runtime to perform the functions described herein. Other components of the system 100 shown in FIG. 1 may be comprised of machine readable instructions stored in the memory 306 during runtime and executed by the processor 302. The components of the system 100 may run on one or multiple computer systems. For example, the query manager 130 and the storage engines 120a-x may run on different computer systems and thus may be stored in the memory of their respective computer systems. Also, the computer system 300 may comprise multiple processors and multiple memories and each may store machine readable instructions for different components of the system 100. Commands and data from the processor 302 are communicated over a communication bus 303. The machine readable instructions and data for the processor 302 may reside in the memory 306 during runtime, and may be stored in a secondary data storage 308, which may be non-volatile. The memory 306 and data storage 308 are examples of computer readable mediums.

The computer system 300 may include an I/O device 310, such as a keyboard, a mouse, a display, etc. The computer system 300 may include a network interface 312 for connecting to a network. Other known electronic components may be added or substituted in the computer system 300. Also, the data storage system 100 may be implemented in a distributed computing environment, such as a cloud system.

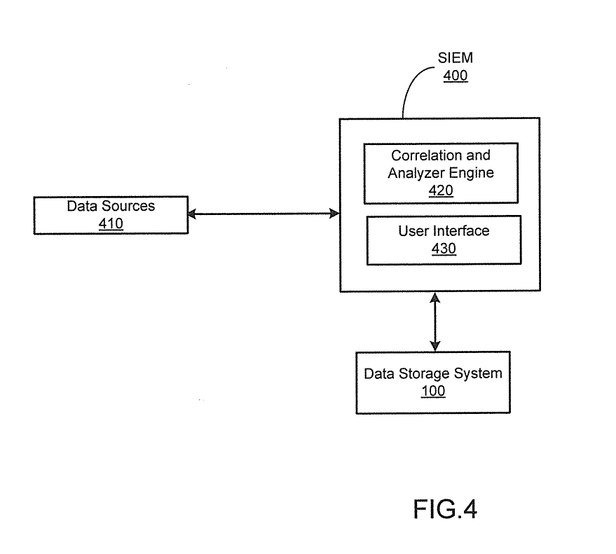

FIG. 4 illustrates a Security Information and Event Management system (SIEM) 400 connected to the data storage system 100 of FIG. 1. The SIEM 400 receives event data from data sources 410, which may include network devices generating log files, network management systems, or other types of data sources generating event data.

The SIEM 400 also includes correlation and analyzer engine 420 to correlate and analyze the event data to identify threats or determine other information associated with events. Correlating and analyzing event data may include automated detection and remediation in near real-time, and post analytics, such as reporting, pattern discovery, and incident handling.

Correlation may include correlating event data with users and assets to associate activities described in event data with particular users and assets. For example, information for an event may be correlated with attributes of a user and an asset associated with an event. For example, event data may include a unique user identifier (UUID), asset ID or IP address and application event fields and these fields are used to look up user and asset information in the data storage system 100 to identify a user and asset having those attributes at the time the event occurred. In an example, an attack is detected, which was allowed by a firewall, and it targeted a machine that was found to be vulnerable by a vulnerability scanner. Correlating the event information with asset data can determine attributes of the machine that may be comprised and may identify parent groups of machines that may also be comprised by the attack.

Analyzing event data may include using rules to evaluate each event with network model and vulnerability information to develop real-time threat summaries. This may include identifying multiple individual events that collectively satisfy one or more rule conditions such that an action is triggered. The aggregated events may be from different data sources and are collectively indicative of a common incident representing a security threat as defined by one or more rules. The actions triggered by the rules may include notifications transmitted to designated destinations (e.g., security analysts may be notified via consoles e-mail messages, a call to a telephone, cellular telephone, voicemail box and/or pager number or address, or by way of a message to another communication device and/or address such as a facsimile machine, etc.) and/or instructions to network devices to take action to thwart a suspected attack (e.g., by reconfiguring one or more of the network devices, and or modifying or updating access lists, etc.). The information sent with the notification can be configured to include the most relevant data based on the event that occurred and the requirements of the analyst.

The SIEM 400 may maintains reports regarding the status of security threats and their resolution. The SIEM 400 may provide notifications and reports through a user interface 430 or by sending the information to users or other systems. Users may also enter domain schema information and other information via the user interface 430.

The SIEM 400 may also send queries to the data storage system 100 for correlation and analysis of the event data. As described above, the data storage system may parse a query to generate sub queries to run on different database tables. Results may be joined and/or sorted and provided back to the SIEM 400.

While the embodiments have been described with reference to examples, various modifications to the described embodiments may be made without departing from the scope of the claimed embodiments.

What is claimed is:

1. A data storage system comprising:
a query manager executed by at least one processor to receive a query, and to identify storage engines to execute the query; and
storage engines, wherein a first of the storage engines executes a portion of the query on a row-oriented table and a second of the storage engines executes a second portion of the query on a column-oriented table, and the row- oriented table and the column-oriented table are for the same database.

2. The data storage system of claim 1, wherein the query manager is to receive results of the portion of the query executed on the row-oriented table and the second portion of the query executed on the column-oriented table and is to perform operations on the results to determine results for the query.

3. The data storage system of claim 2, wherein the operations performed on the results to determine the results for the query comprise a join or a sort.

4. The data storage system of claim 1, wherein the query manager is to store meta data describing the data stored in each table, whether each table is column-oriented or row-oriented, and the storage engine associated with each table, and the query manager is to use the meta data to identify the first and second storage engines from a set of storage engines.

5. The data storage system of claim 1, wherein the database is to store security event information for a network.

6. The data storage system of claim 5, wherein the security event information comprises event data and the data storage system is to receive the event data from a security information and event management system receiving the event data from a plurality of sources.

7. A non-transitory computer readable medium storing machine readable instructions that are executable by at least one processor to:
receive a query;
parse the query into sub queries;
identify storage engines from a plurality storage engines to execute the sub queries based on tables associated with the storage engines and information requested in the sub queries; and
send the sub queries to the storage engines, wherein a first of the storage engines executes a first of the sub queries on a row-oriented table and a second of the storage engines executes a second of the sub queries on a column-oriented table, and the row-oriented table and the column-oriented table are for the same database.

8. The non-transitory computer readable medium of claim 7, wherein the machine readable instructions are executable by the at least one processor to:
receive results of the sub queries from the storage engines; and
perform operations on the results to generate query results for the received query.

9. The non-transitory computer readable medium of claim 8, wherein the operations performed on the results comprise a join or a sort.

10. The non-transitory computer readable medium of claim 7, wherein the machine readable instructions are executable by the at least one processor to:
store meta data describing the data stored in each table, whether each table is column-oriented or row-oriented, and the storage engine associated with each table.

11. The non-transitory computer readable medium of claim 10, wherein the machine readable instructions are executable by the at least one processor to:
identify the first and second storage engines from a set of storage engines according to information in the meta data.

12. A method of performing a query in a data storage system, the method comprising:
receiving a query;
parsing the query into sub queries;
identifying, by at least one processor, storage engines from a plurality storage engines to execute the sub queries based on tables associated with the storage engines and information requested in the sub queries;
sending the sub queries to the storage engines, wherein a first of the storage engines executes a first of the sub queries on a row-oriented table and a second of the storage engines executes a second of the sub queries on a column- oriented table, and the row-oriented table and the column-oriented table are for the same database;
receiving results of the sub queries from the storage engines; and
performing operations on the results to generate query results for the received query.

13. The method of claim 12, comprising:
storing meta data describing the data stored in each table, whether each table is column-oriented or row-oriented, and the storage engine associated with each table.

14. The method of claim 13, comprising:
identifying the first and second storage engines from a set of storage engines according to information in the meta data.

15. The method of claim 12, wherein the operations performed on the results comprise a join or a sort.
